(19) United States
(12) Patent Application Publication
(10) Pub. No.: US 2011/0196710 A1
(43) Pub. Date: Aug. 11, 2011

(54) AGRICULTURAL SERVICES SYSTEM THAT FACILITATES FARMER COMMUNICATIONS, CROP INSURANCE, COMMODITY CONTRACS AND CARBON CREDITS

(76) Inventor: BINDU RAMA RAO, Laguna Niguel, CA (US)

(21) Appl. No.: 13/092,951

(22) Filed: Apr. 24, 2011

Related U.S. Application Data
(63) Continuation-in-part of application No. 12/221,876, filed on Aug. 6, 2008.

(51) Int. Cl. G06Q 40/00; G06Q 10/00

(52) U.S. Cl. 705/4; 705/37; 705/1.1

(57) ABSTRACT

A system for agricultural services for farmers and agribusiness (and for other types of users too) facilitates communications with farmers, and between farmers, provides crop insurance to farmers, helps creation and management of commodity contracts, assignment, verification and trading of green house credits, etc. The system comprises a plurality of mobile devices, wherein each of the plurality of mobile devices is employed by one of a plurality of farmers, and a server. The server is communicatively coupled to the plurality of mobile devices and it collects a farmer information from each of the plurality farmers, via an associated one of the plurality of mobile devices that the farmer employs. The farmers use a mobile device to communicate with the server as part of the agriculture related services, or to communicate with each other via the server. The server computes an insurance amount for each of the plurality of farmers based on the corresponding farmer's farmer information and based on an associated historical data (for that farmer, and across all farmers).

### CROSS REFERENCES TO RELATED APPLICATIONS

The present patent application is a continuation-in-part of, claims priority to, and makes reference to U.S. non-provisional patent Ser. No. 12/221876, entitled “Mobile device for access to agricultural services by non-literate and semi-literate users”, filed on Aug. 6, 2008. The complete subject matter of the above-referenced United States Patent Application is hereby incorporated herein by reference, in its entirety.

### BACKGROUND

1. Technical Field

This present invention relates generally to a farmers and agricultural services and more particularly to a server that collects a farmer information and supports insurance, greenhouse credits and trading in greenhouse credits and commodities.

2. Related Art

Some solutions for agribusiness and some farming related websites/servers are available in the market and farmers can access some information from their personal computers at home. However, any farmer solutions available today on the internet are of limited functionality and do not provide a whole lot of value to a farmer other than as generic websites. Some websites provide some instructional material for farmers, and a few offer to sell farming equipment to farmers.

There are several unmet needs for farmers and agribusiness. There is need for farmers to access various types of market pricing information in a timely manner. Farmers cannot get market pricing information without logging into computers and browsing websites—often in evenings at home after work—seldom can such information be available to the farmer in the fields.

A lot is being made of greenhouse gases and how farmers can benefit from greenhouse credits. However, none of that discussion has made its way into any viable solutions. There is an unmet need for farmers and other users to accumulate and frequently access greenhouse credits—there are no services that a farmer can use today to create and manage his specific set of greenhouse credits. In addition, traditional crop insurance does not have access to historical data (that is easily accessible and verifiable) that is relevant to that specific farmer/rancher. This is a problem too.

Some insurance companies and banks have offered farming insurance. These are not geared towards adhoc insurance services, and are not flexible, nor easy to subscribe to. There is an unmet need for a farmer to, on an adhoc basis, determine cost and availability of insurance for his harvest in the current or next crop cycle—in an easy and efficient manner. No such solutions exist.

There are no means by which a farmer can provide information about his specific crops and farmland to bank, insurance companies, etc. This is vital for new services but no mechanisms exist.

Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of a system for agriculture related services that facilitates communications with farmers and between farmers, providing crop insurance to farmers, creation and management of commodity contracts and assignment, verification and trading of green house credits.

FIG. 2 is another perspective diagram of a system for agriculture related services and green energy that facilitates interaction with various users, and the computation of greenhouse credits for various activities executed by their users.

FIG. 3 is a flow chart of an exemplary operation of the server of the present invention, as it manages greenhouse credits for a user and facilitates trading in greenhouse credits.

### DETAILED DESCRIPTION OF THE DRAWINGS

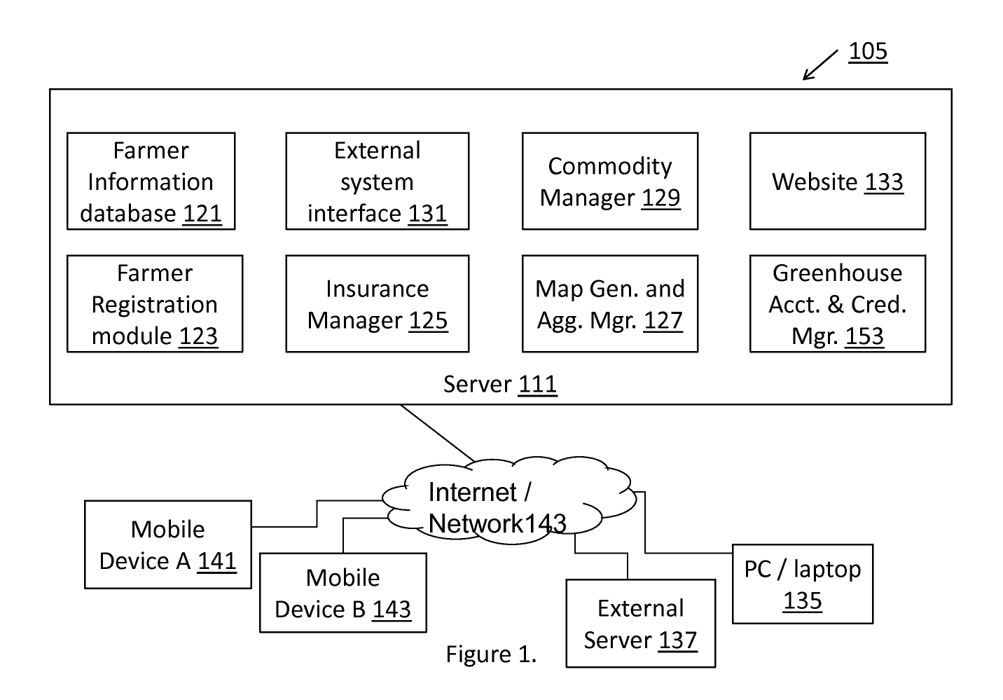

FIG. 1 is a perspective block diagram of a system for agriculture related services 105 that facilitates communications with farmers and between farmers, providing crop insurance to farmers, creation and management of commodity contracts and assignment, verification and trading of green house credits. The system 105 comprises a plurality of mobile devices, wherein each of the plurality of mobile devices is employed by one of a plurality of farmers, and a server. The server is communicatively coupled to the plurality of mobile devices 141, 143, and it collects a farmer information from each of the plurality farmers, via an associated one of the plurality of mobile devices 141, 143 that the farmer employs—the farmers use a mobile device to communicate with the server as part of the agriculture related services, or to communicate with each other via the server 111. The server 111 computes an insurance amount for each of the plurality of farmers based on the corresponding farmer's farmer information and based on an associated historical data (for that farmer, and across all farmers).

The server 111 offers insurance to each of the plurality of farmers for a next crop cycle by presenting the insurance amount for that farmer, and the server 111 acts on an insurance response received from the each of the plurality of farmers (on their mobile devices 141, 143 for example, or on a PC/laptop 135). The server 111, periodically and when requested by a user (such as a farmer), generates a commodity report based on the farmer information collected from each of the plurality of farmers. The farmer information for each farmer is stored in a farmer information database 121 in the server 111. The server 111 communicates the commodity report to an external system, such as an external server 137.

The present invention supports a multiperil crop insurance offering. The scheme can be implemented such that all farmers who take agricultural loans from any financial institution can avail of this insurance service. Other farmers who do not take any loans can also seek insurance. The present invention makes it possible to incorporate subsidies for part of the insurance premium payment, such subsidies being paid by contract farming companies, for governmental organizations, etc. Thus part of payment premium can be subsidized for farmers who own less than some minimum amount of land (for example). In addition, the current invention supports an “area approach to insurance”, wherein instead of individual farmers, a specific area is insured. The area may vary from one location/region or administrative unit to another. It can also be dependent of crop types. A farmer, whose yield falls below a historically calculated amount, is compensated if his insurance premium has been paid up.

In one embodiment, the crop-revenue insurance: is supported by the present invention wherein a combination of crop-yield insurance and price insurance is incorporated. For example, a governmental agency or a private group involved in agribusiness establishes crop-revenue insurance guarantees on a crop such as corn, by multiplying each farmer's yield (such as corn-yield) guarantee, which is based on the farmer's own production history, times the harvest-time futures price discovered at a commodity exchange (such as Chicago exchange) before the policy is sold to that farmer and the crop is planted by that farmer.

In general, the farmer information retrieved, for example, from the mobile devices 141, 143, used by the farmers, get stored in the farmer information database 121. The farmer information typically various types of information, such as crop types grown, quantity of crops corresponding to those crop types, acreage under harvest, availability of water, infestations of insects, anticipated yield and weather related problems.

The server 111 presents a map (to the users, such as farmers, agribusiness, etc.) for a whole region, such as a county, a district, a state, a country, or a village, based on a collection of farmer information from the plurality of farmers, wherein the map highlights one or more of crop types, quantity of crops corresponding to those crop types, location information, acreage under harvest for each crop type, availability of water, infestations of insects and weather related problems, wherein the map is presented to at least the plurality of mobile devices 141, 143. The map is typically interactive and a user (such as a farmer) can select an area on the map and the server 111 aggregates data for that area on the map, wherein the data comprises quantity of crops corresponding to those crop types, acreage under harvest, availability of water, infestations of insects, anticipated yield and weather related problems.

The system for agriculture related services 105 supports providing insurance services to farmers. The server 111 computes the insurance amount for each of the plurality of farmers incorporating at least an aggregated crop yield estimates for that region, aggregated inputs estimates for that region and crop type, historical data for that crop variety, yield per acre previously observed for that plot of land, insurance amount paid historically in that region and by each of the plurality of farmers, current market prices, etc. An insurance manager 125 in the server 111 provides insurance management services—offering insurance to farmers, interacting with farmers on insurance issues, collecting harvest related data for those farmers who choose to accept insurance, compute insurance amounts for each farmer based on historical data for that region, crop type, plot type (farm type), weather conditions, market prices and several other factors. Thus, farmers are given the option to accept crop insurance for a next crop cycle, for a whole year, etc. The server 111 offers insurance to farmers, by employing insurance related messages that are communicated to the mobile devices 141, 143 of the farmers (for example). The server 111 utilizes responses by farmers to provide insurance services, manage them and keep the farmer covered with insurance.

A website 133, associated with the server 111, is capable of providing management screens and agricultural data screens for farmers and other users to interact with the server and access services. The website 133 presents aggregated agricultural data via the agricultural data screens, wherein the aggregated agricultural data comprises aggregated data on crop types grown, aggregated data on quantity of crops corresponding to those crop types, aggregated data on acreage under harvest, aggregated data on availability of water, aggregated data on infestations of insects, aggregated data on anticipated yield aggregated data on weather related problems, aggregated crop yield estimates by region and sub-regions, aggregated inputs estimates for that region and crop type, historical data for each crop variety, yield per acre previously observed for individual plots of land in a region or sub-region, insurance amount paid historically in a region or sub-region and by each of the plurality of farmers, current market prices, etc. A map generator and aggregation manager 127 facilitates aggregation of various types of data across all farmers in a region/sub-region, across all crop varieties of a crop type, etc. The aggregated data that the map generator and aggregation manager 127 generates/computes is displayed in maps or in tables and charts, as necessary. Such maps/tables/chart of aggregated data is accessed by a user (such as a farmer) via a mobile device 141, or via the PC/laptop 135 (that may employ the website 133 for data access/download).

The system for agriculture related services 105 supports assigning greenhouse credits to users (such as farmers, storing such credits in greenhouse credits accounts created for, and managed by, the farmers (and other users). The website 133, associated with the server 111, computes and presents greenhouse gases related greenhouse gas credits for each farmer, for example. Such greenhouse gas credits associated with each of the plurality of farmers can be accumulated with the help of a greenhouse account & credits manager 153. The greenhouse gas credits are computed (for example) for avoiding loss of greenhouse gases from the soil in one or more ways by a farmer, avoiding emissions from tractors, combines and fertilizers associated with growing crops, adopting of green farming techniques, etc.

The system for agriculture related services 105 supports issuing greenhouse credits in general, and carbon credits in particular, to farmers and other users/companies. The website 133 issues carbon credits or Certified Emission Reductions (CER) that are certifiable, based on farmer information received from the plurality of farmers. The website 133 certifies and registers the carbon credits (greenhouse credits in general) with trading organizations associated with a climate exchange for trading of greenhouse gases and subsequently trades them for cash on behalf of the plurality of farmers.

The website 133, associated with the server 111 facilitates computing commodity prices for the various types of crops grown by the plurality of farmers using the system 105. It uses a commodity manager 129 to mange computation and display of commodity prices. The website 133 presents a commodity pricing for each of the crop types associated with the plurality of farmers, wherein the commodity pricing is based on anticipated yield for each of the crop types, weather observations, insect problem observations, and other related reports and observations by the plurality of farmers.

The website 133, associated with the server 111, supports selective certification of various produce grown by the plurality of farmers who employ the system 105. For example, it supports selective certification of various produce as “green”, certification as “grown locally”, etc. The server 111, for at least one batch of produce created by one of the plurality of farmers, automatically tracks and retrieves (when necessary) the source location (such as the place/village where it is grown and) where it is harvested and a destination location where it is delivered. The server 111 automatically determines a distance-from-origin by computing the distance between the source location and the destination location for the produce and farmers that it tracks. The server 111 certifies each of produce as “produced locally” if the corresponding distance-from-origin computed is below a threshold distance (such as 10 miles around a city, for example).

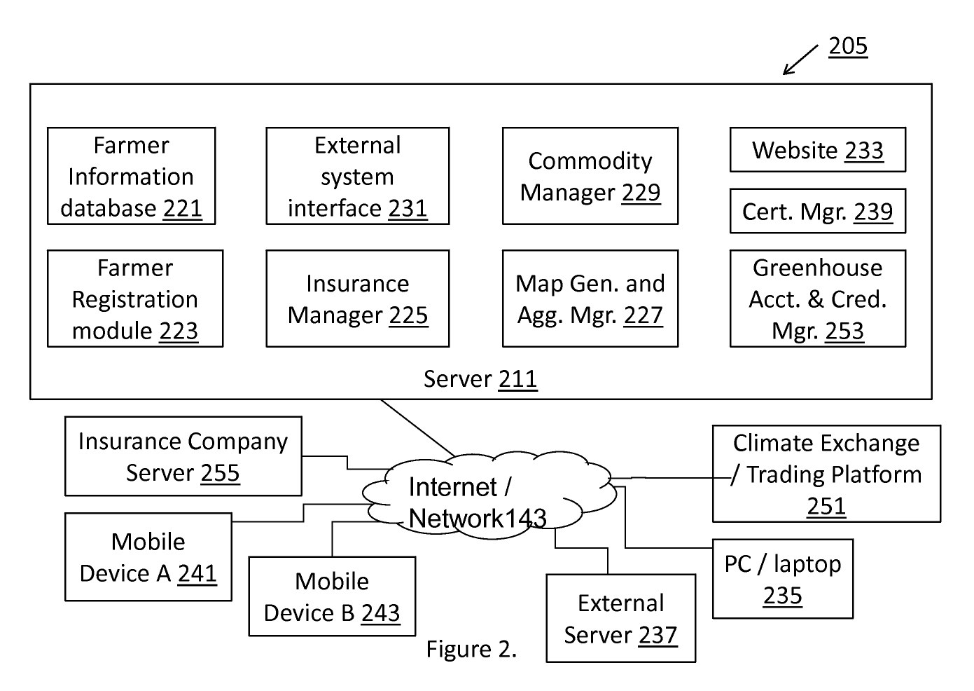

FIG. 2 is another perspective diagram of a system 205 for agriculture related services and green energy that facilitates interaction with various users, and the computation of greenhouse credits for various activities executed by their users. The system 205 comprises a server 211 capable of interacting with remote PCs 235, computers and mobile devices 141, 143 while it supports access by a plurality of users (such as farmers, for example—other types of users, both in agribusiness and elsewhere, are also contemplated).

The server 211 facilitates creation and management of greenhouse credits account for the plurality of users. A website 233 associated with the server 211 enables the plurality of users to accumulate all their greenhouse credits into their associated greenhouse credits accounts that are maintained by and managed at the server 111. The website 233 issues Certified Emission Reductions (CER) that are certifiable to the plurality of users, based on their associated greenhouse credits account. The website 233 certifies and registers the CER for the plurality of users with a trading organization associated with a climate exchange/trading platform 251, for trading of greenhouse credits held by the plurality of users. The website trades the CER on behalf of each of the plurality of users and deposits corresponding funds into a bank account associated with that each of the plurality of users.

Each of the plurality of the users interchangeably employ a corresponding mobile device 241, 243 or a personal computer/laptop 235 to manage their greenhouse credit account, that are managed by the server 211. The users also manage their greenhouse credits and associated CER, bank account (one or more banking accounts registered by the user during a registration operation, for example) and funds available at the bank account. The server 211 automatically retrieves a user activity information from the remote PCs/laptop 135, computers and mobile devices 241, 243, used by the plurality of users and updates the associated greenhouse credits accounts for the users. A greenhouse account & credit manager 253 facilitates creation and management of greenhouse credits accounts for the users, such accounts typically maintained and managed at the server 211, or optionally maintained and managed at an external server 237.

In one embodiment the plurality of users are farmers. The server 211, for all the produce grown/harvested by the plurality of users, automatically retrieves the source location where the produce is harvested and a destination location where it is delivered (for sale). The server 211 automatically determines a distance-from-origin by computing the distance between the source location and the destination location. The server 211, employing a certification manager 239, certifies each of batches of produce as “produced locally” if the corresponding distance-from-origin computed is below a threshold distance (such as a 10-mile radius around a city). In a related embodiment, the server 233 certifies batches of produce as “organic” if the server determines that the associated plurality of users who are farmers have not used any fertilizers and have not used any pesticides to grow those batches of produce. Other types of certifications of produce are also contemplated.

In one embodiment, each of the plurality of users is a farmer who produces crops, seeks insurance, seeks carbon credits (greenhouse credits in general), seeks certification (as locally grown food or organically grown food, for example), etc. The website 233 computes a sequestered carbon amount for each of the plurality of users and stores that computed value in the greenhouse credits account associated each of the plurality of users, the greenhouse account & credit manager 253 facilitating management of such greenhouse credits accounts and manipulation of such greenhouse credits accounts, such as for trading in greenhouse credits on behalf of a user. The sequestered carbon amount is computed based on verified “green data” comprising one or more of a conservation tillage, a conservation or riparian buffers information, a grazing land management information, a reduction in the use of synthetic fertilizer, a green mode of handling manure, a mode of capturing and burning of methane, a reduction of irrigation, and a switching to biofuels, as initially reported by and subsequently verified for each of the plurality of users.

An insurance company server 255 is employed selectively by the insurance manager 225 of the server 211 to provide insurance services to farmers who opt for insurance for their crops/harvest. In one embodiment, the server 211 selectively shares a farmer information associated with a farmer with the insurance company server 255 to determines insurance costs, such as cost of covering a next crop cycle for the farmer, cost of insuring the farming equipment for that farmer, etc. It presents that insurance costs to the farmer and seeks his acceptance. For example, it presents that insurance costs to the farmer over the farmer's mobile device A 241, receives the farmer's acceptance, and then activates that insurance. It also collects (and forwards to the insurance company server 255, if necessary) documentation and observations over time, that are insurance related, such as harvesting activities and harvesting quantities, over time, from the farmer and from other related sources.

The server 211 collects and manages a collection of farmer information from each of a plurality of farmers, wherein farmer information comprises information on one or more of crop types grown by a farmer, location where they are grown, quantity of crops corresponding to those crop types, acreage under harvest for each crop type, availability of water, infestations of insects and weather related problems. The server 211 presents a map for a region based wherein the map displays aggregate data derived from the farmer information from each of a plurality of farmers. The server 211 computes an insurance amount for each of the farmers and offers insurance to that farmer, based on the collection of farmer information. The server 211 assigns and activates insurance to those of the plurality of farmers who accept the offers of insurance. The server 211, based on the collection of farmer information, creates a commodity report and publishes it for access by users on the Internet/network 143 and by the plurality of farmers over their mobile devices 241, 243. The server 211 optionally communicates the commodity report to an external server 237. The server 211 facilitates creation of a commodity futures contract by each of the plurality of farmers. It also facilitates conducting a commodity futures contract transaction on a climate exchange/trading platform (sometimes referred to as a futures exchange) 251, for each of the plurality of farmers to which the server 211 is communicatively coupled.

The server 211 also facilitates crop rotation by each of the plurality of farmers by recommending alternate crops to each of the plurality of farmers based on the collection of farmer information (such as those stored in the farmer information database 221) and based upon a historical data (for the farmer, for the region, for the weather pattern, for the plot of land involved, etc.) relevant to each of the plurality of farmers.

The individual farmer projections of produce anticipated, produce actual, produce delta from anticipated is monitored, tracked, rolled into figures for the whole county/district/region, and cumulative figures for whole company across various states/regions is computed and presented on server 211. Individual farmer problems with water, insects, and weather is aggregated for whole region, county/district/state and shown on management screen via the website 233. An individual farmer is also provided crop insurance based on aggregated crop problems computed, crop yields computed for the region and crop type, and historical data. This insurance offer incorporates crop type, yield per acre historically in that region and by that farmer, current market prices, etc.

The server 211 in present invention computes green energy related greenhouse credits (such as carbon credits) for each type greenhouse gas sequestration. It computes them for different techniques, different crop in different regions/country.

The server 211 in present invention computes commodity market pricing based on anticipated yield of a product type, weather observations, insect problem observations, produce crop types and anticipated yields, yield related observations, and other relevant data, most of which is reported by the various farmers themselves, as it is observed in their farms, farmland and neighborhood.

The server 211 in present invention computes the amount of sequestered carbon—and the reduction of emissions of methane and nitrous oxide in a variety of ways, in each farmland, in each region/sub-region. Computation of sequestered carbon is computed based on data reported/observed by the farmers and field extension agents, for example, and included conservation tillage, conservation or riparian buffers, grazing land management, reducing the use of synthetic fertilizer, handling manure differently, capturing and burning methane, reducing irrigation, switching to biofuels, etc.

The server 211 in present invention facilitates computing carbon credits for individual farmers. There are at least two components when valuing Carbon Credits (CCs)—carbon credit covers the emission of 1 ton of carbondioxide. The first revolves around the price at which Carbon Credits are changing hands in a climate exchange (for example). The second, often more challenging conundrum, is determining what qualifies for the issuing of a Carbon Credit. The most obvious are the sequestration of carbon in trees and the use of renewables to generate electricity (wind, solar, hydro, tidal), and the present invention supports these. The present invention also helps in identifying programs that exist to purchase and sell the carbon credits, that are created from these sequestration activities. The server 211 identifies farmers who are willing to commit to carbon sequestration activities, and computes payments due to them for sequestering carbon. Carbon sequestration by individual farmers is computed, and aggregated for a whole region, whole company or whole organization.

The present invention also supports tracking the usage of biogas by farms and agribusiness. For biogas generated by individual farms, the number of carbon credits the farmers were able to trade is computed, and often these are based on the amount of methane that does not enter the atmosphere, thanks to their anaerobic (for biogas generation) digester. Through renewable energy development, farms can be economically viable because they are environmentally sustainable, and the server 211 tracks such phenomenon based on reports and observations made by individual farmers and agribusiness.

In general the server 211 sells carbon credits to the climate exchanges such as the Chicago Climate Exchange, as well as directly to power companies, industries, and other organizations. The server 211 also certifies and registers the farmers carbon credits with trading organizations such as the Chicago Climate Exchange and later trades them for cash, as instructed by the farmers and agribusiness, or based on preferences and policies.

In one embodiment, the server 211 and the website 233 are integrated into the same unit.

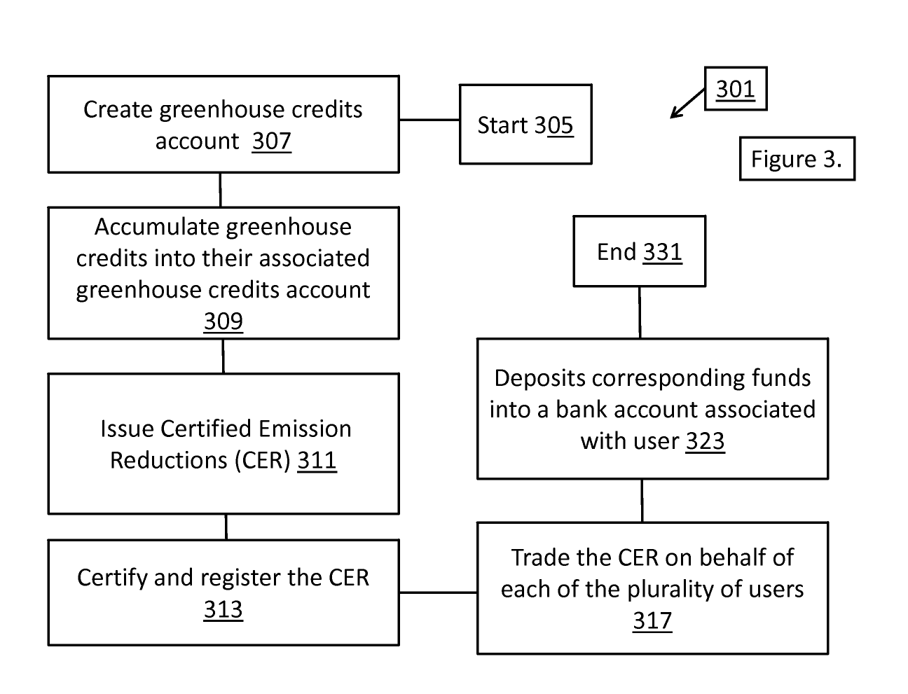

FIG. 3 is a flow chart of an exemplary operation of the server 211 of the present invention, as it manages greenhouse credits for a user and facilitates trading in greenhouse credits. The processing starts at a start block 305 where the server 211 is ready to support user interactions from remote PCs, computers and mobile devices. The server 211 is then ready to facilitate creation and management of greenhouse credits account for the plurality of users. At a next block 307, the server (employing its website as necessary, for example) helps a user create greenhouse credits account. At a next block 309, the server 211 helps users to accumulate all their greenhouse credits into their associated greenhouse credits accounts. Then, at a next block 311, it issues Certified Emission Reductions (CER) that is certifiable to the plurality of users, based on their associated greenhouse credits accounts.

Then, at a next block 313, it certifies and registers the CER for the plurality of users with a trading organization associated with a climate exchange, for trading of greenhouse credits held by the plurality of users. At a next block 317, it trades the CER on behalf of each of the plurality of users. At a next block 323, it deposits corresponding funds into a bank account associated with that each of the plurality of users. Finally, processing for the operation terminates at the end block 331.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above in terms of agriculture related services and green energy. It should be clear that the greenhouse gas related concepts is applicable to other industries that are different from agribusiness and agriculture. Alternate industries such as renewable energy companies, geothermal energy generation, etc. can benefit from the present invention, especially as it relates to the server 211 facilitating the creation and management of greenhouse credits account for the plurality of users, and the trading of greenhouse credits at a climate exchange.

The present invention has also been described above with the aid of method steps illustrating the performance of specified functions and relationships thereof The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A system for agriculture related services, the system comprising:
a plurality of mobile devices, wherein each of the plurality of mobile devices is employed by one of a plurality of farmers;
a server communicatively coupled to the plurality of mobile devices, wherein the server collects a farmer information from each of the plurality farmers via an associated one of the plurality of mobile devices;
the server computes an insurance amount for each of the plurality of farmers based on the corresponding farmer's farmer information and an associated historical data;
the server offers insurance to each of the plurality of farmers for a next crop cycle by presenting at least the insurance amount for that farmer, and the server acts on an insurance response received from the each of the plurality of farmers;
the server, periodically and when requested, generates a commodity report based on the farmer information collected from each of the plurality of farmers; and
the server communicates the commodity report to an external system.

2. The system of claim 1 wherein the farmer information comprises crop types grown, quantity of crops corresponding to those crop types, acreage under harvest, availability of water, infestations of insects, anticipated yield and weather related problems.

3. The system of claim 2 wherein the server presents a map for a whole region, a county, a district, a state, a country, or a village, based on a collection of farmer information from the plurality of farmers, wherein the map highlights one or more of crop types, quantity of crops corresponding to those crop types, location information, acreage under harvest for each crop type, availability of water, infestations of insects and weather related problems, wherein the map is presented to at least the plurality of mobile devices.

4. The system of claim 3 wherein the map is interactive and a user can select an area on the map and the server aggregates data for that area on the map, wherein the data comprises quantity of crops corresponding to those crop types, acreage under harvest, availability of water, infestations of insects, anticipated yield and weather related problems.

5. The system of claim 2 wherein the server computes the insurance amount for each of the plurality of farmers incorporating at least an aggregated crop yield estimates for that region, aggregated inputs estimates for that region and crop type, historical data for that crop variety, yield per acre previously observed for that plot of land, insurance amount paid historically in that region and by each of the plurality of farmers, and current market prices.

6. The system of claim 2 further comprises:
a website, associated with the server, capable of providing management screens and agricultural data screens; and
the website presenting aggregated agricultural data via the agricultural data screens, wherein the aggregated agricultural data comprises at least aggregated data on crop types grown, aggregated data on quantity of crops corresponding to those crop types, aggregated data on acreage under harvest, aggregated data on availability of water, aggregated data on infestations of insects, aggregated data on anticipated yield aggregated data on weather related problems, aggregated crop yield estimates by region and sub-regions, aggregated inputs estimates for that region and crop type, historical data for each crop variety, yield per acre previously observed for individual plots of land in a region or sub-region, insurance amount paid historically in a region or sub-region and by each of the plurality of farmers, and current market prices.

7. The system of claim 2 further comprises:
a website, associated with the server, computing and presenting greenhouse gases related greenhouse gas credits associated with each of the plurality of farmers, wherein the greenhouse gas credits are computed for avoiding loss of greenhouse gases from the soil in one or more ways, avoiding emissions from tractors, combines and fertilizers associated with growing crops, and the adoption of green farming techniques.

8. The system of claim 7 further comprises:
the website issues carbon credits or Certified Emission Reductions (CER) that are certifiable, based at least on farmer information received from the plurality of farmers; and
the website certifies and registers the carbon credits with trading organizations associated with a climate exchange for trading of greenhouse gases and subsequently trades them for cash on behalf of the plurality of farmers.

9. The system of claim 2 further comprises:
a website, associated with the server, computing and presenting a commodity pricing for each of the crop types associated with the plurality of farmers, wherein the commodity pricing is based on anticipated yield for each of the crop types, weather observations, insect problem observations, and other related reports and observations by the plurality of farmers.

10. The system of claim 2 further comprising
a website, associated with the server;
the server, for at least one batch of produce created by one of the plurality of farmers, automatically retrieves the source location where it is harvested and a destination location where it is delivered;
the server automatically determines a distance-from-origin by computing the distance between the source location and the destination location; and
the server certifies each of the at least one batch of produce as “produced locally” if the corresponding distance-from-origin computed is below a threshold distance.

11. A system for agriculture related services and green energy, the system comprising:
a server capable of interacting with remote PCs, computers and mobile devices and supporting access by a plurality of users;
the server facilitates creation and management of greenhouse credits account for the plurality of users;
a website associated with the server that enables the plurality of users to accumulate all their greenhouse credits into their associated greenhouse credits account;
the website issues Certified Emission Reductions (CER), that are certifiable to the plurality of users, based on their associated greenhouse credits account;
the website certifies and registers the CER for the plurality of users with a trading organization associated with a climate exchange, for trading of greenhouse credits held by the plurality of users; and
the website trades the CER on behalf of each of the plurality of users and deposits corresponding funds into a bank account associated with that each of the plurality of users.

12. The system of claim 11 wherein each of the plurality of the users interchangeably employ a corresponding mobile device or a personal computer to manage their greenhouse credit account, their greenhouse credits and associated CER, bank account and funds at the bank account.

13. The system of claim 12 wherein the server automatically retrieves a user activity information from the remote PCs, computers and mobile devices used by the plurality of users and updates the associated greenhouse credits accounts for the plurality of users.

14. The system of claim 12 wherein the plurality of users are farmers, the system further comprising:
the server, for at least one batch of produce harvested by one of the plurality of users, automatically retrieves the source location where it is harvested and a destination location where it is delivered;
the server automatically determines a distance-from-origin by computing the distance between the source location and the destination location; and
the server certifies each of the at least one batch of produce as “produced locally” if the corresponding distance-from-origin computed is below a threshold distance.

15. The system of claim 14 wherein the server certifies the at least one batch of produce as “organic” if the server determines that the associated plurality of users who are farmers have not used any fertilizers and have not used any pesticides to grow that at least one batch of produce.

16. The system of claim 11 wherein each of the plurality of users is a farmer, the system further comprising:
the website computing a sequestered carbon amount for each of the plurality of users and storing it in the greenhouse credits account associated with that each of the plurality of users, wherein the sequestered carbon amount is computed based on verified green data comprising one or more of a conservation tillage information, a conservation or riparian buffers information, a grazing land management information, a reduction in the use of synthetic fertilizer, a green of handling manure, a data on capturing and burning of methane, a reduction of irrigation, and a switching to biofuels, as initially reported by and subsequently verified for each of the plurality of users.

17. A server for agribusiness, the server comprising:
the server collects and manages a collection of farmer information from each of a plurality of farmers, wherein farmer information comprises information on one or more of crop types grown by a farmer, location where they are grown, quantity of crops corresponding to those crop types, acreage under harvest for each crop type, availability of water, infestations of insects and weather related problems; and
the server presents a map for a region wherein the map displays aggregate data derived from the farmer information from each of a plurality of farmers.

18. The server of claim 17 further comprising:
the server computes an insurance amount for each of the farmers and offers insurance to that farmer, based on the collection of farmer information; and
the server assigns and activates insurance to those of the plurality of farmers who accept the offers of insurance.

19. The server of claim 17 further comprising:
the server, based on the collection of farmer information, creating a commodity report and publishing it for access by users on the Internet and by the plurality of farmers over their mobile devices;
the server optionally communicates the commodity report to an external server;
the server facilitates creation of a commodity futures contract by each of the plurality of farmers; and
the server facilitates conducting a commodity futures contract transaction on a futures exchange, for each of the plurality of farmers to which the server is communicatively coupled.

20. The server of claim 17 further comprising:
the server facilitates crop rotation by each of the plurality of farmers by recommending alternate crops to each of the plurality of farmers based on the collection of farmer information and based upon a historical data relevant to each of the plurality of farmers.
